(19) United States
(12) Patent Application Publication
(10) Pub. No.: US 2014/0317558 A1
(43) Pub. Date: Oct. 23, 2014

(54) METHOD AND APPARATUS FOR ADDING SEGMENT MARKS IN A WEB PAGE

(71) Applicant: Tencent Technology (Shenzhen) Company Limited, Shenzhen City (CN)

(72) Inventor: Heng WANG, Shenzhen City (CN)

(73) Assignee: Tencent Technology (Shenzhen) Company Limited, Shenzhen City (CN)

(21) Appl. No.: 14/262,585

(22) Filed: Apr. 25, 2014

Related U.S. Application Data
(63) Continuation of application No. PCT/CN2013/091042, filed on Dec. 31, 2013.

(30) Foreign Application Priority Data
Apr. 22, 2013 (CN) 201310140339.7

(51) Int. Cl. G06F 3/0485

(52) U.S. Cl. CPC G06F 3/04855
USPC 715/786

(57) ABSTRACT

A method and apparatus for adding segment marks in a web page are proposed. The method includes: acquiring an information attribute of an information piece displayed by a web browser, and grouping information pieces having a same information attribute into a same information segment; acquiring ratios of the number of information pieces within every information segment to the total number of information pieces displayed by the web browser; setting segment marks at particular locations of a scroll bar of the web browser in accordance with the ratios; and displaying the segment marks. The method can inform a user of information amounts of other pages and the reading progress of the user when the user is reading a current page.

### CROSS-REFERENCE TO RELATED APPLICATIONS

This application is a U.S. continuation application of International Application PCT/CN2013/091042, with an international filing date of Dec. 31, 2013, which claims the priority benefit of Chinese Patent Application No. 201310140339.7 filed on Apr. 22, 2013, the contents of which are both incorporated herein by reference in their entireties for all intended purposes.

### FIELD

The disclosure relates to the field of web browsing, and in particular, to a method and apparatus for adding segment marks in a web page.

### BACKGROUND

When a user browses a web page, a website content provider usually provides all contents for the user's viewing in segments by means of, for example, paging display or segment loading, with a purpose of avoiding problems such as excessive information amount, too slow loading speed, and so on caused by loading all contents at once. However, current paging display or segment loading is loading of equivalent amount of information (usually, the numbers of information pieces in every page or segment are equal). That is, information loaded within every page or segment has the same amount, and the paging display or segment loading is not performed in accordance with information attributes (for example, time attribute). In some website services arranging contents in a reverse chronological order (for example, Social Network Services (SNS) such as Twitter and so on), the time attribute of information usually is a factor that is particularly focused on by the user.

Paging display or segment loading in accordance with information attributes usually leads to different amount of information loaded within every page or segment. With these methods, a scroll bar of a web page can only provide the amount of information within a current page, and cannot inform the user of the amount of information within other pages.

### SUMMARY

Proposed is a method and apparatus for adding segment marks in a web page, which are capable of, when a user is reading a current page, informing the user of amount of information within other pages.

A method for adding segment marks in a web page in accordance with an embodiment of the invention includes: acquiring an information attribute of an information piece displayed by a web browser, and setting information pieces having a same information attribute into a same information segment; acquiring ratios of the number of information pieces within every information segment to the total number of information pieces displayed by the web browser; setting segment marks at particular locations of a scroll bar of the web browser in accordance with the ratios; and displaying the segment marks.

An apparatus for adding segment marks in a web page in accordance with an embodiment of the invention includes: an information attribute acquiring module for acquiring an information attribute of an information piece displayed by a web browser, and setting information pieces having a same information attribute into a same information segment; a acquiring module for acquiring ratios of the number of information pieces within every information segment to the total number of information pieces displayed by the web browser; a marking module for setting segment marks at particular locations of a scroll bar of the web browser in accordance with the ratios; and a displaying module for displaying the segment marks.

The method and apparatus for adding segment marks in a web page in accordance with an embodiment of the invention can add marks in the web page for convenience of reviewing.

### DESCRIPTION OF THE DRAWINGS

FIG. 1 is a flow diagram of a method for adding segment marks in a web page in accordance with an embodiment of the invention;

FIG. 2 is a diagram of a display effect in accordance with an embodiment of the invention;

FIG. 3 is another diagram of a display effect in accordance with an embodiment of the invention;

FIG. 4 is a structural diagram of an apparatus for adding segment marks in a web page in accordance with an embodiment of the invention; and

FIG. 5 is a structure diagram of example hardware architecture of a terminal in which the method and apparatus for adding segment marks in a web page in accordance with an embodiment of the invention can be implemented.

### DETAILED DESCRIPTION

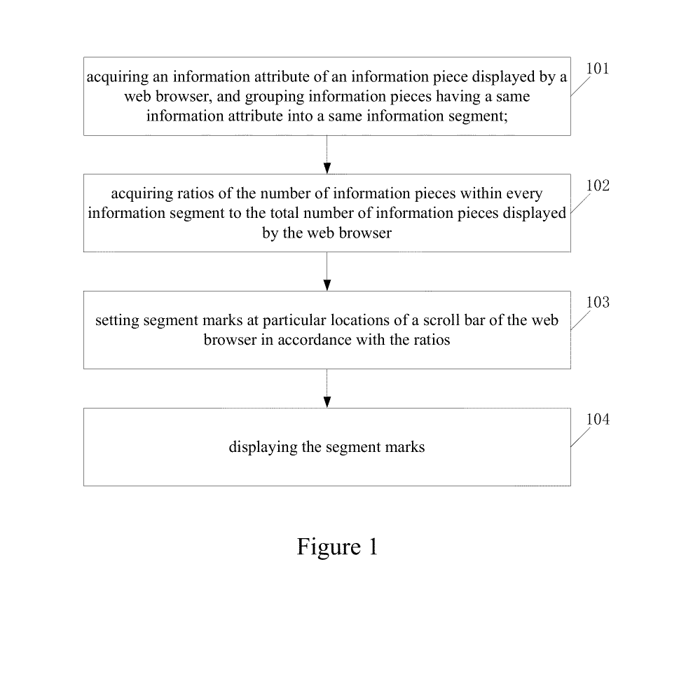

A method for adding segment marks in a web page is proposed. FIG. 1 is flow chart of the method for adding segment marks in a web page in accordance with an embodiment of the invention. As shown in FIG. 1, the method includes:

Step 101: acquiring an information attribute of an information piece displayed by a web browser, and grouping information pieces having a same information attribute into a same information segment;

Step 102: acquiring ratios of the number of information pieces within every information segment to the total number of information pieces displayed by the web browser;

Step 103: setting segment marks at particular locations of a scroll bar of the web browser in accordance with the ratios; and

Step 104: displaying the segment marks. In the above step 101, the information attribute can be specifically date attribute; for example, a information piece is published on May 2, and the information attribute of the information piece is “May 2”; the information segment can be specifically an information segment consisting of all information pieces having the same date attribute; for example, multiple information pieces are published on May 2, and all the information pieces published on May 2 belong to the information segment having the date attribute of “May 2”. Alternatively the information attribute can be specifically an information publisher identifier; for example, a information piece is published by a user “A”, and the information attribute of the information piece is “A”; the information segment can be specifically an information segment consisting of all information pieces having the same information publisher identifier; for example, the user “A” publishes multiple information pieces, and all information pieces published by the user “A” belong to the information segment having the information attribute “A”.

In the above step 102, the way of acquiring the ratios of the number of information pieces within every information segment to the total number of information pieces displayed by the web browser is: when detecting that information attributes of two adjacent information pieces displayed by the web browser are different, inserting a node between the two adjacent information pieces, wherein the node carries the information attribute of the latter of the two adjacent information pieces; based on nodes inserted into a queue of information pieces displayed by the web browser, acquiring the total number of information pieces displayed by the web browser and the number of information pieces within every information segment, and obtaining the ratios of the number of information pieces within every information segment to the total number of information pieces displayed by the web browser by dividing the total number of information pieces displayed by the web browser by the number of information pieces within every information segment.

In the above step 103, the way of setting the segment marks at the particular locations of the scroll bar of the web browser in accordance with the ratios is: setting node signs at dividing point locations, in accordance with the radios, within a height range of the scroll bar of the web browser.

In the above method, after the node is inserted between the two adjacent information pieces, the method can further include: setting the information piece before the node as ending information piece of the information segment in which the information piece before the node exists, and setting the information piece after the node as starting information piece of the information segment in which the information piece after the node exists.

In the above method, the information attribute can be specifically a time attribute (for example, a date attribute) or an information publisher identifier.

Below, the method for adding segment marks in a web page in accordance with an embodiment of the invention is described in detail by specific embodiments in conjunction with accompany drawings.

### EMBODIMENT I

A method for adding segment marks in a web page in accordance with the embodiment includes the following steps:

Step 1: a website server pulls latest information pieces within information segments of “m” information attributes in accordance with the information attributes, and transmits the information pieces to a client, wherein each information piece carries its own information attribute.

Step 2: when detecting that information attributes of two adjacent information pieces in a queue of received information pieces are different, the client inserts a node between the two adjacent information pieces and adds the information attribute of the latter of the two adjacent information pieces on the node, wherein the information piece before the inserted node is ending information piece of an information segment in which the information piece before the inserted node exists, and the information piece after the inserted node is starting information piece of an information segment in which the information piece after the inserted node exists.

Step 3: based on nodes inserted to the queue of received information pieces, the client acquires the total number “N” of the latest information pieces within the information segments of the “m” information attributes and the numbers “n1”, “n2”, . . . , “nm” of information pieces within information segments of every information attribute, and calculates the information proportions “p” of information segments of every information attribute (i.e., the ratios between the number of information pieces of every information attribute and the total number of the latest information pieces within the information segments of the “m” information attributes, p1=n1/N, p2=n2/N, . . . , pm=nm/N);

Step 4: the client sets node signs at particular locations neighboring or on a scroll bar in a web browser in accordance with the information proportions “p” of information segments of every information attribute, wherein the particular locations are dividing points for dividing in accordance with the information proportions “p” of the information segments of every information attribute within a height range of the scroll bar.

### EMBODIMENT II

A method for adding segment marks in a web page in accordance with an embodiment of the invention includes the following steps:

Step 1: a website server pulls information pieces of latest “m” days and transmits the information pieces to a client, wherein each information piece carries its own time mark containing year, month and date information;

Step 2: when detecting that the date information in time marks of two adjacent information pieces in a queue of received information pieces are different, the client inserts a node between the two adjacent information pieces and adds a date attribute of the latter of the two adjacent information pieces on the inserted node, wherein the information piece before the inserted node is ending information piece of an information segment of the date to which the information piece before the inserted node belongs, and the information piece after the inserted node is starting information piece of an information segment of the date to which the information piece after the inserted node belongs.

Step 3: based on the nodes inserted in the queue of received information pieces, the client acquires the total number “N” of information pieces of the latest m days and the numbers “n1”, “n2”, . . . “nm” of information pieces of every day, and calculates information proportions “p” of every day (that, the ratios between the number of information pieces of every day and the total number of information pieces of the latest m days, p1=n1/N, p2=n2/N, . . . ,pm=nm/N).

Step 4: the client sets node signs at particular locations neighboring or on a scroll bar in a web browser in accordance with the information proportions “p” of every day, wherein the particular locations are dividing points for dividing in accordance with the information proportions “p” of every day within a height range of the scroll bar.

### EMBODIMENT III

A method for adding segment marks in a web page in accordance with the embodiment includes the following steps:

Step 1: a website server pulls information pieces of latest several days (for example, information pieces of latest three days, i.e. May 3, 2012, May 2, 2012, and May 1, 2012), and transmits the information pieces to a client, wherein each information piece carries its own time mark containing year-month-date-hour-minute-second information.

Step 2: when detecting that date information in the time marks of two adjacent information pieces in a queue of received information pieces are different, the client inserts a date node between the two adjacent information pieces, adds the date attribute of the information piece after the inserted date node on the inserted date node, marks earlier information piece of the two adjacent information pieces as ending information piece of an information segment of the date to which the earlier information piece belongs, and marks later information piece of the two information pieces as starting information piece of an information segment of the date to which the later information piece belongs.

For example, there are 20 information pieces on May 3, 2012, 30 information pieces on May 2, 2012, and 40 information pieces on May 1, 2012. When detecting that the date information of a earliest information piece on May 3, 2012 is “3” and the date information of a latest information piece on May 2, 2012 is “2”, which is different from the date information of the former information piece (i.e., the earliest information piece on May 3, 2013), the client inserts a date node between the earliest information piece on May 3, 2012 and the latest information piece on May 2, 2012 and adds the date attribute of “May 2, 2012” on the inserted date node; when detecting that the date information of a last information piece on May 2, 2012 is “2” and the date information of a first information piece on May 1, 2012 is “1”, which is different from the date information of the former information piece (i.e., the last information piece on May 2, 2013), the client inserts a date node between the last information piece on May 2, 2012 and the first information piece on May 1, 2012 and adds the date attribute of “May 1, 2012” on the inserted date node.

Step 3: based on the date nodes inserted in a queue of received information pieces, the client acquires the total number “N” of information pieces of the several days and the numbers “n” of information pieces of every day, and calculates information proportions “p” of every day (that is, the ratios “p=n/N” between the number of information pieces of every day and the total number of information pieces of the several days).

For example, in the embodiment, the total number of information pieces of the latest 3 days is N=20+30+40=90; the number “n1” of information pieces on May 3 between the date node carrying the date attribute of “May 3” and the date node carrying the date attribute of “May 2” is 20; the number “n2” of information pieces on May 2 between the date node carrying the date attribute of “May 2” and the date node carrying the date attribute of “May 1” is 30; the number “n3” of information pieces on May 1 after the date node carrying the date attribute of “May 1” is 40; the ratio between the number of information pieces on May 3 and the total number of information pieces on the three days is p1=20/90=2/9, the ratio between the number of information pieces on May 2 and the total number of information pieces on the three days is p2=30/90=3/9, and the ratio between the number of information pieces on May 1 and the total number of information pieces on the three days is p3=40/90=4/9.

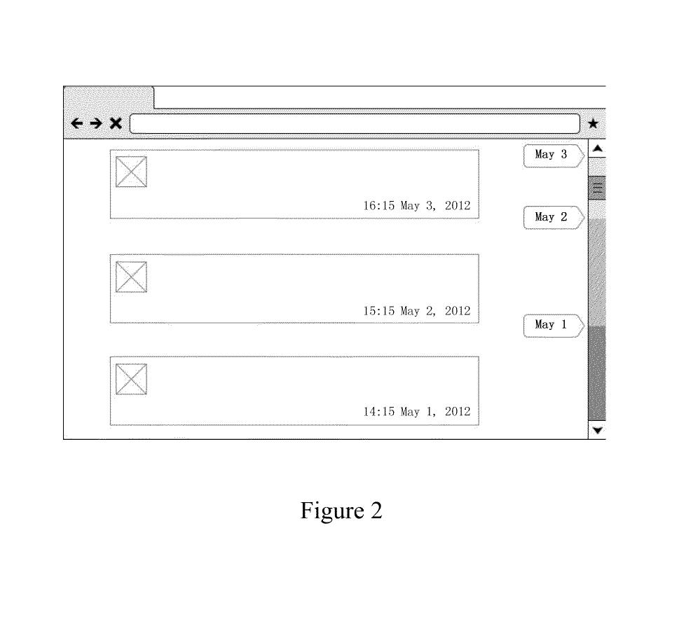

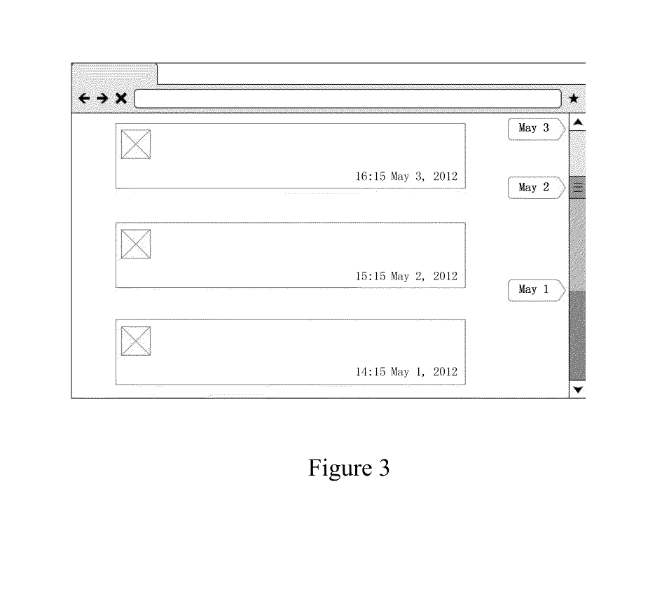

Step 4: the client sets node signs at particular locations neighboring or on a scroll bar in a web browser in accordance with the information proportions “p” of every day. The particular locations are dividing points for dividing in accordance with the information proportions of every day within a height range of the scroll bar. For example, in the embodiment, as shown in FIG. 2, “May 3”, “May 2”, and “May 1” are marked in turn. When the scroll bar scrolls within a segment of “May 3”, information pieces on May 3 are browsed, the amount of information that has been browsed by the user and the amount of rest information that has not been browsed by the user on May 3 can be displayed, and the ratios between the information amount on May 3 and the information amounts on May 2 and May 1 can be displayed. When the scroll bar scrolls to the mark point of “May 2”, as shown in FIG. 3, it is indicated that the information pieces on May 3 has been completely browsed, and it is started to browse the information pieces on May 2.

### EMBODIMENT IV

In the embodiment, the information attribute is specifically an information publisher identifier. A method for adding segment marks in a web page in accordance with the embodiment includes:

Step 1: a website server pulls latest information pieces published by “m” users and transmits the information pieces to a client, wherein each information piece carries an information publisher identifier thereof.

Step 2: when detecting that the information publisher identifiers of two adjacent information pieces in a queue of received information pieces are different, the client inserts a node between the two adjacent information pieces and adds the information publisher identifier of the latter of the two adjacent information pieces on the inserted node, wherein the information piece before the inserted node is ending information piece of an information segment of the former user, and the information piece after the inserted node is starting information piece of an information segment of the current user.

Step 3: based on the nodes inserted in a queue of received information pieces, the client acquires the total number “N” of the latest information pieces published by the “m” users and the numbers “n1”, “n2”, . . . , “nm” of information pieces published by every user, and calculates the information proportions “p” of every user, i.e. the ratios between the number of information pieces published by every user and the total number of the latest information pieces published by the “m” users p1=n1/N, p2=n2/N, . . . pm=nm/N.

Step 4: the client sets node signs at particular locations neighboring a scroll bar in a web browser or on the scroll bar in accordance with the proportions “p” of information published by every user, wherein the particular locations are dividing points for dividing in accordance with the proportions “p” of information published by every user within a height range of the scroll bar.

It is noted that the above described embodiment I to embodiment IV impliedly disclose the following processing of the client after receiving the queue of information pieces transmitted by the website server: acquiring information attributes of information pieces in the received queue of information pieces (that is, information pieces displayed on a web browser), and grouping information pieces having a same information attribute in a same information segment. Specifically, the processing of the client inserting a node between two adjacent information pieces in the received queue of information pieces when detecting that the information attributes of the two adjacent information pieces are different can be considered as a specific implementation of the above processing of the client. Furthermore, in the above described embodiment Ito embodiment IV, the node signs set at the particular locations neighboring the scroll bar in the web browser or on the scroll bar can be considered as segment marks, and are corresponding to the nodes inserted in the received queue of information pieces by the client.

The invention further proposes an apparatus for adding segment marks in a web page.

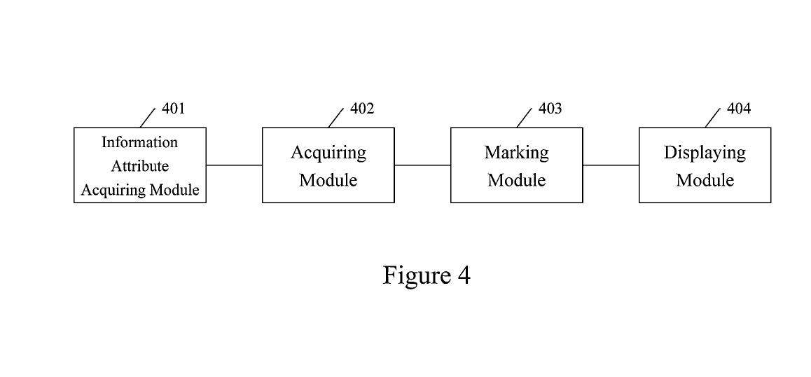

FIG. 4 is a structural diagram of an apparatus for adding segment marks in a web page in accordance with an embodiment of the invention. As shown in FIG. 4, the apparatus includes: an information attribute acquiring module 401 for acquiring an information attribute of an information piece displayed by a web browser, and grouping information pieces having a same information attribute into a same information segment; a acquiring module 402 for acquiring ratios between the number of information pieces within every information segment and the total number of information pieces displayed by the web browser; a marking module 403 for setting segment marks at particular locations of a scroll bar of the web browser in accordance with the ratios calculated by the acquiring module 402; and a displaying module 404 for displaying the segment marks.

In the above apparatus, the acquiring module 402 acquires the ratios between the number of information pieces within every information segment and the total number of information pieces displayed by the web browser by the following processing: when detecting that information attributes of two adjacent information pieces displayed by the web browser are different, inserting a node between the two information pieces, wherein the node carries an information attribute of the latter of the two adjacent information pieces; based on nodes inserted into a queue of received information pieces displayed by the web browser, calculating the total number of information pieces displayed by the web browser and the number of information pieces within every information segment, and obtaining the ratios between the number of information pieces within every information segment and the total number of information pieces displayed by the web browser by dividing the total number of information pieces displayed by the web browser by the number of information pieces within every information segment.

The marking module 403 sets the segment marks at the particular locations of the scroll bar of the web browser in accordance with the ratios calculated by the acquiring module 402 by the following processing: setting node signs at dividing points for dividing in accordance with the radios within a height range of the scroll bar of the web browser.

The marking module 403 is further configured for setting the information piece before the node as ending information piece of an information segment in which the information piece before the node exists, and setting the information piece after the node as starting information piece of an information segment in which the information piece after the node exists.

In the above apparatus, the information attribute can be a date attribute or an information publisher identifier.

In the above embodiments, the present invention is illustrated with date or information publisher identifier as the example of the information attribute. In the example of date, the same information attribute, for example, may refer to the date of the same day; in the example of information publisher identifier, the same information attribute, for example, may refer to the publisher of the same person. However, information attribute is not limited to those examples, and may be set as desired according to particular contents and displays. In addition, they can be used in single or in combination. For example, the information published by a person at a day may be regarded as having the same information attribute.

The method and apparatus for adding segment marks in a web page described in conjunction with FIGS. 1-4 are applicable to various types of terminal, such as a desktop computer, a portable computer, a tablet computer, a feature phone, a smart phone, a Personal Digital Assistant (PDA) and so on. Although some specific components of the terminals are different, primary constituting portions of them are substantially the same.

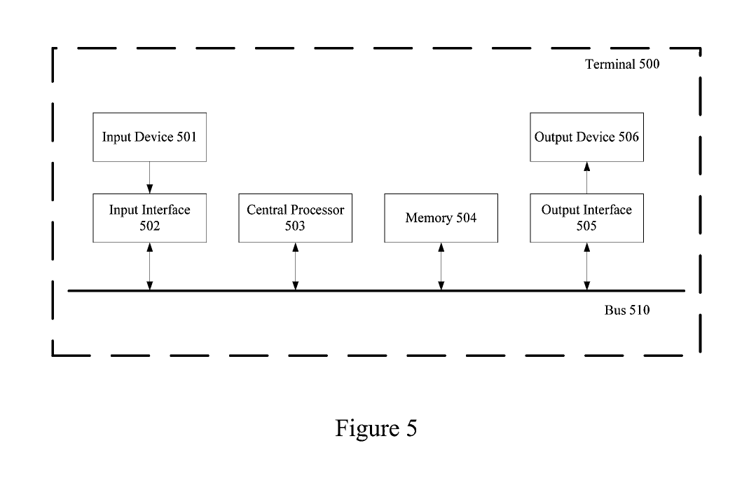

FIG. 5 is a structure diagram of example hardware architecture of a smart terminal. As shown in FIG. 5, a smart terminal 500 mainly includes an input device 501, an input interface 502, a central processor 503, a memory 504, an output interface 505, and an output device 506. The input interface 502, the central processor 503, the memory 504, and the output interface 505 are interconnected via a bus 510, and the input device 502 and the output device 506 are connected to the bus 510 via the input interface 502 and the output interface 505 respectively and then connected to other components in the smart terminal 500. Specifically, the input device 501 receives input information from external, and transmits the input information to the central processor 503 via the input interface 502; the central processor 503 processes the input information to generate output information, temporarily or persistently stores the output information in the memory 504, and then transmits the output information to the output device 506 via the output interface 505; the output device 506 outputs the output information to external of the smart terminal 500 for use by a user.

Actually, a terminal, in which the method and apparatus for adding segment marks in a web page proposed in the invention is implemented, can inform a user the information amounts of other pages when the user is reading a current page by acquiring the number of information pieces of every segment and their proportions and correspondingly setting node signs on the scroll bar. In addition, it can inform the user of the reading progress of the user by adding and displaying node signs.

The sequence numbers of the above embodiments of the disclosure are only for the purpose of description, and do not represent one embodiment is superior to another.

The above are merely prefer embodiments of the invention, and cannot be used to limit the protection scopes of the invention. Any amendment, equivalent alternative, improvement and so on within the sprite and principle of the invention shall be contained in the protection scopes of the invention.

What is claimed is:

1. A method for adding segment marks in a web page, including:
acquiring an information attribute of an information piece displayed by a web browser, and grouping information pieces having a same information attribute into a same information segment;
acquiring ratios of the number of information pieces within every information segment to the total number of information pieces displayed by the web browser;
setting segment marks at particular locations of a scroll bar of the web browser in accordance with the ratios; and
displaying the segment marks.

2. The method of claim 1, wherein acquiring the ratios of the number of information pieces within every information segment to the total number of information pieces displayed by the web browser includes:
inserting a node between two adjacent information pieces displayed by the web browser if they have different information attributes, wherein the node carries the information attribute of the latter of the two adjacent information pieces;
calculating the total number of information pieces displayed by the web browser and the number of information pieces within every information segment based on the node inserted into a queue of information pieces displayed by the web browser; and
acquiring the ratios of the number of information pieces within every information segment to the total number of information pieces displayed by the web browser by dividing the total number of information pieces displayed by the web browser by the number of information pieces within every information segment.

3. The method of claim 2, wherein setting the segment marks at the particular locations of the scroll bar of the web browser in accordance with the ratios includes:
setting node signs at dividing point locations which divide the scroll bar of the web browser in height based on the radios.

4. The method of claim 2, wherein the method further includes, after inserting the node between the two adjacent information pieces, the following processing:
setting the information piece before the node as ending information piece of the information segment in which the information piece before the node exists, and setting the information piece after the node as starting information piece of the information segment in which the information piece after the node exists.

5. The method of claim 1, wherein the information attribute is date or information publisher identifier.

6. An apparatus for adding segment marks in a web page, including:
an information attribute acquiring module for acquiring an information attribute of an information piece displayed by a web browser, and for grouping information pieces having a same information attribute into a same information segment;
a acquiring module for acquiring ratios of the number of information pieces within every information segment to the total number of information pieces displayed by the web browser;
a marking module for setting segment marks at particular locations of a scroll bar of the web browser in accordance with the ratios; and
a displaying module for displaying the segment marks.

7. The apparatus of claim 6, wherein the acquiring module acquires the ratios of the number of information pieces within every information segment to the total number of information pieces displayed by the web browser by:
inserting a node between two adjacent information pieces displayed by the web browser if they have different information attributes, wherein the node carries the information attribute of the latter of the two adjacent information pieces;
acquiring the total number of information pieces displayed by the web browser and the number of information pieces within every information segment based on nodes inserted into a queue of information pieces displayed by the web browser; and
obtaining the ratios of the number of information pieces within every information segment to the total number of information pieces displayed by the web browser by dividing the total number of information pieces displayed by the web browser by the number of information pieces within every information segment.

8. The apparatus of claim 7, wherein the marking module sets the segment marks at the particular locations of the scroll bar of the web browser in accordance with the ratios by:
setting node signs at dividing point locations which divides the scroll bar of the web browser in height based on the radios.

9. The apparatus of claim 7, wherein the marking module is further configured for:
setting the information piece before the node as ending information piece of the information segment in which the information piece before the node exists, and setting the information piece after the node as starting information piece of the information segment in which the information piece after the node exists.

10. The apparatus of claim 6, wherein the information attribute is date or information publisher identifier.

11. A terminal including the apparatus for adding segment marks in a web browser, the apparatus including:
an information attribute acquiring module for acquiring an information attribute of an information piece displayed by a web browser, and for grouping information pieces having a same information attribute into a same information segment;
a acquiring module for acquiring ratios of the number of information pieces within every information segment to the total number of information pieces displayed by the web browser;
a marking module for setting segment marks at particular locations of a scroll bar of the web browser in accordance with the ratios; and
a displaying module for displaying the segment marks.
